(19) United States
(12) Patent Application Publication
(10) Pub. No.: US 2004/0054082 A1
(43) Pub. Date: Mar. 18, 2004

(54) Toughened polymer blends with improved surface properties

(76) Inventors: David H Bank, Midland, MI (US); James D. Oelberg, Auburn, MI (US); Sarada P. Namhata, Midland, MI (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 10/451,981

(22) PCT Filed: Dec. 3, 2001
(86) PCT No.: PCT/US01/46503

(51) Int. Cl. C08L 75/00

(52) U.S. Cl. 525/123

(57) ABSTRACT

A polymer blend suitable for preparing molded articles, fibers and films comprising: a) a syndiotactic monovinylidene aromatic polymer, b1) nylon 6,6, b2) nylon 6, nylon 6/6,6 copolymer, or a mixture of nylon 6 and nylon 6/6,6 copolymer and c) a compatibilizer able to impart improved adhesion between components a), b1) and b2).

The present invention relates to a polymeric blend of a syndiotactic monovinylidene aromatic polymer and two specific polyamide polymers.

Blends of syndiotactic monovinylidene aromatic polymers, such as syndiotactic polystyrene (SPS) and polyamides, commonly known as nylon, are known in the art, having excellent impact and heat resistance properties. Typically, these types of blends are toughened using various rubbery polymers. For example, U.S. Pat. No. 5,395,890 issued to Nakano et al. discloses a resin composition containing SPS, nylon and optionally a rubbery block polymer. Additionally, U.S. Pat. No. 5,219,940 discloses SPS and polyamide blends, optionally containing block or grafted rubbers. U.S. Pat. No. 5,270,353 discloses blends of SPS with nylon toughened with block and maleated block copolymers. U.S. Pat. No. 6,093,771 disclosed blends of syndiotactic monovinylidene aromatic polymers and polyamides of relatively low molecular weight (high viscosity number). Numerous polyamides as well as mixtures thereof were disclosed as being suitable for use in such blends. In the field of fiber production, blends of nylon 6 and nylon 6,6 have been previously employed in order to produce fibers having improved crystallization kinetics, draw properties and/or dye acceptance.

A problem with the foregoing resin blends is that in order to obtain molded articles having smooth surfaces that accurately reproduce the surface features of the mold, it is generally necessary to employ mold temperatures that are above about 150° C., necessitating the use of a non-aqueous heat transfer fluid to control the mold temperature. Otherwise, the surface features of the resulting molded article are poor, resulting in articles having rough surfaces and poor reproduction of mold details. Molding equipment designed to operate at higher molding temperatures is generally more expensive to purchase and operate than equipment that operates at lower molding temperatures. In addition, a greater risk of personal injury in the event of equipment malfunction or cooling line rupture is also present when operating under the above described more extreme processing conditions. Accordingly, there remains a need for SPS/polyamide blend compositions that may be utilized under less rigorous molding or film forming conditions yet produce acceptable surface properties in the resulting molded parts. In the field of fiber spinning and yarn formation, it is desired to produce fibers having improved hand or texture as well as spinability.

The present invention is a polymer blend comprising:

a) a syndiotactic monovinylidene aromatic polymer,

b1) nylon 6,6,

b2) nylon 6, nylon 6/6,6 copolymer, or a mixture of nylon 6 and nylon 6/6,6 copolymer, and

c) a compatibilizer able to impart improved adhesion between components a), b1) and b2).

Additional components of the present molding composition include one or more optional compounds selected from the group consisting of rubbery polymers, toughening agents, compatibilizers, nucleators, lubricants, softeners, fillers (including conductive fillers and fillers to improve surface plating properties), reinforcing aids, blowing agents, ignition resistance additives (including flame and drip suppressants, smoke suppressants, and char formers), stabilizers (including heat and light stabilizers), antioxidants, extrusion aids, mold release aids, anti-blocking additives, dessicants, colorants, and dyes.

The foregoing blends are better suited for use in preparing moldings having good surface smoothness and mold reproduction properties while operating at lower mold temperatures compared to previously known blends of a syndiotactic monovinylidene aromatic resin and a polyamide resin. In addition, such blends are highly suited for use in forming films of improved smoothness for use as packaging and printing substrates and for forming fibers having good surface properties under melt spinning conditions, especially at reduced spinneret temperatures and/or high spinneret throughput. Such fibers are highly suited for use in preparing yarns for carpet, roving, and woven or non-woven cloth.

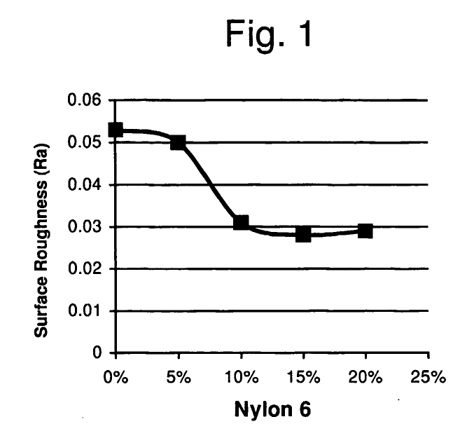

FIG. 1 is a graph of the surface roughness of articles prepared according to Example 1.

As used herein, the term “syndiotactic” refers to polymers having a stereoregular structure of greater than 90 percent syndiotactic, preferably greater than 95 percent syndiotactic, of a racemic triad as determined by ¹³C nuclear magnetic resonance spectroscopy. For purposes of United States patent practice, the contents of any patent, patent application or publication referenced herein are hereby incorporated by reference in their entirety, especially with respect to the disclosure of synthetic techniques and general knowledge in the art. As used herein the term “comprising” is not intended to exclude the presence of any additional component, step or procedure, whether or not the same is disclosed herein. Unless stated to the contrary, all percentages of components herein are based on total composition weight.

Monovinylidene aromatic polymers are homopolymers and copolymers of vinyl aromatic monomers, that is, monomers whose chemical structure possess both an unsaturated moiety and an aromatic moiety. The preferred vinyl aromatic monomers have the formula: H₂C═CR—Ar; wherein R is hydrogen or an alkyl group having from 1 to 4 carbon atoms, and Ar is an aromatic radical of from 6 to 10 carbon atoms. Examples of such vinyl aromatic monomers are styrene, α-methylstyrene, vinyltoluene, t-butylstyrene, vinyl naphthalene, divinylbenzene, and mixtures thereof. Suitable mixtures specifically include mixtures of isomers of the foregoing compounds, especially isomers of vinyltoluene, including mixtures of p-methylstyrene and o-methylstyrene in any proportion. syndiotactic polystyrene is the preferred syndiotactic monovinylidene aromatic polymer. Typical polymerization processes for producing syndiotactic monovinylidene aromatic polymers are well known in the art and are described in U.S. Pat. Nos. 4,680,353, 5,066,741, 5,206,197, 5,294,685, and elsewhere.

The Mw of the syndiotactic monovinylidene aromatic polymer used in the blend of the present invention is not critical, but is typically from 10,000 to 1,000,000, preferably from 20,000 to 750,000. The method for measuring molecular weights of syndiotactic monovinylidene aromatic polymer components used in the present composition is by any suitable comparative viscosity technique using polystyrene standards. Preferred syndiotactic monovinylidene aromatic polymers have a molecular weight distribution (Mw/Mn) from 1.1 to 50, preferably from 1.2 to 5.0. The amount of syndiotactic monovinylidene aromatic polymer present in the blend of the present invention is typically from 1.0 to 97.9 weight percent. For resins used for molding or film formation, the quantity of syndiotactic monovinylidene aromatic polymer preferably ranges from 10 to 90 weight percent and more preferably from 15 to 50 weight percent. For resin blends used for drawing or spinning of fibers, the syndiotactic monovinylidene aromatic polymer content of the blend is preferably from 1 to 50 weight percent, preferably from 5 to 30 weight percent.

Polyamides are polycondensation products of amine and carboxylic acid functionalized reagents or precursors thereof. Nylon 6 is prepared by the polycondensation of caprolactam, nylon 6,6 is prepared by the polycondensation of polyhexamethyleneadipamide, and nylon 6/6,6 copolymer is prepared by the copolycondensation of a mixture of caprolactam and polyhexamethyleneadipamide. These polymers are all well known polyamides that are readily commercially available. The Mw of these three polyamides as used in the present invention is not critical but is typically from 40,000 to 60,000. Alternatively, the polymers may be defined by viscosity number, VN, which is determined by measuring the viscosity of a 0.5 weight percent solution of the polyamide in 96 percent aqueous sulfuric acid at 25° C. (ISO 307 conditions). Suitable polyamides for component b1) and b2) are those having a VN in the range from 1.0 to 500 ml/g, preferably from 1.5 to 200 ml/g, in particular from 1.75 to 150 ml/g. For fiber formation, generally lower VN number resins are employed, especially polymers having VN from 1.5 to 5.0. The polymers may be modified to change the normal distribution of chain end functionality if desired. Examples of a suitable nylon 6,6, nylon 6, and nylon 6/6,6 copolymer resins for use herein are Vydyne™ 50BW, Vydyne™ NA217, and Vydyne™ IF 75A, respectively, all of which are available from Solutia, Inc.

The amount of polyamide b1) present in the blend of the present invention is typically from 1.0 to 97.9 weight percent. For molding resins, the quantity of polyamide b 1) is preferably from 10 to 60 weight percent and more preferably from 10 to 50 weight percent. For resin blends used in forming films or fibers, the quantity of polyamide b1) is preferably from 0.1 to 30.0 weight percent and more preferably from 0.5 to 25 weight percent. The amount of polyamide b2) present in the invention is typically from 1.0 to 97.9 weight percent. For molding resins, the amount is preferably from 4 to 15 weight percent, and most preferably from 5 to 10 weight percent. For resin blends used in forming films or fibers, the quantity of polyamide b2) is preferably from 75 to 97.5 weight percent and more preferably from 80 to 95 weight percent. Desirably, the ratio of component b2) to b1) is limited to the range from 1/10 to 10/1. At higher contents of b2) in the blend, and lower ratios of b2)/b 1), the heat distortion properties of the resin blend are sacrificed without appreciable additional improvement in surface smoothness. At lower contents of b2) in the blend, and at lower ratios of b2)/b 1), surface smoothness of articles is not significantly improved.

Component c) of the present invention is a compound that acts as a compatibilizer for the syndiotactic monovinylidene aromatic polymer and the polyamide components b1) and b2). Suitable compatibilizers are those wherein the resin blend demonstrates increased tensile or flexural modulus or strength compared to a blend lacking in such compatibilizer. Preferred compatibilizers are polymers having a functionality that is miscible or partially miscible with the monovinylidene aromatic polymer and a functionality that is miscible or partially miscible with the polyamide. Typically, the compatibilizer is a polyarylene ether or a copolymer of a monovinylidene aromatic monomer and a polyarylene ether containing polar group functionality and copolymers, including graft copolymers, of a monovinylidene aromatic polymer containing polar group functionality. Functionalized copolymers of monovinylidene aromatic monomers and polyarylene ethers are disclosed in U.S. Pat. No. 5,270,353. Polyphenylene ethers are normally prepared by an oxidative coupling reaction of the corresponding bisphenol compound. A preferred polyarylene ether is poly(2,6-dimethyl-1,4-phenylene)ether. Polyarylene ethers are a known class of polymer having been previously described in U.S. Pat. Nos. 3,306,874, 3,306,875, 3,257,357, and 3,257,358. Preferred functionalized polyarylene ethers are prepared by a graft reaction of the polyarylene ether and a polar group containing reagent. The reaction is normally conducted at an elevated temperature, preferably in a melt of the polyarylene ether, under conditions to obtain homogeneous incorporation of the functionalizing reagent. Suitable temperatures are from 150° C. to 300° C.

Copolymers of monovinylidene aromatic monomers include block and random copolymers thereof with one or more conjugated dienes, especially butadiene, hydrogenated derivatives thereof, random or pseudo-random copolymers thereof with one or more olefins, especially ethylene, and copolymers of the monovinylidene aromatic monomer and a polymerizable polar group containing monomer. A preferred monovinylidene aromatic monomer is styrene.

Suitable polar groups include the carboxylic acids, dicarboxylic acid anhydrides, carboxylic acid halides, amides, sulfones, oxazolines, epoxies, isocyanates, and amines. Preferred polar group containing reactants and monomers are compounds having up to 20 carbons containing reactive unsaturation, such as ethylenic or aliphatic ring unsaturation, along with the desired polar group functionality. Particularly preferred polar group containing reactants are dicarboxylic acid anhydrides, most preferably maleic anhydride.

Specific examples of suitable copolymers include styrene/maleic anhydride copolymers, maleic anhydride or fumaric acid grafted block copolymers of styrene and butadiene; maleic anhydride or fumaric acid grafted polyphenylene ether/styrene interpolymers; maleic anhydride or fumaric acid grafted ethylene/styrene interpolymers; and maleic anhydride or fumaric acid grafted ethylene/styrene/propylene interpolymers.

Typically the amount of polar group functionalizing reagent employed is from 0.01 percent to 20 percent, preferably from 0.5 to 15 percent, most preferably from 1 to 10 percent by weight based on the weight of polyarylene ether or vinylaromatic monomer/polyarylene ether copolymer. The reaction may be conducted in the presence of a free radical generator such as an organic peroxide or hydroperoxide agent if desired. Preparation of polar group functionalized polyarylene ethers have been previously described in U.S. Pat. Nos. 3,375,228, 4,771,096 and 4,654,405.

The amount of compatibilizing component c) employed in the present resin blend is beneficially from 0.1 to 20 weight percent, preferably from 0.2 to 10, more preferably from 0.5 to 5 weight percent. In a preferred embodiment, the compatibilizer c) is the same as any compatibilizer employed to improve compatibility between any optional rubbery polymer, filler or reinforcing agent and the polymer matrix. In addition, the compatibilizer c) may in part or in total be in the form of a coating applied to the outer surface of an optional filler or reinforcing agent, or as part or all of a polymeric compatibilizer resin added to the blend to impart compatibility between the filler or reinforcing agent and the polymer matrix. Such a surface coating is suitably applied to the reinforcing agent by contacting the same with a solution or emulsion of the compatibilizer c). Suitable solvents for dissolving the compatibilizer to form a solution or for use in preparing an emulsion of a water-in-oil or oil-in-water type include methylene chloride, trichloromethane, trichloroethylene and trichloroethane. Preferably the concentration of compatibilizer in the solution or emulsion is from 0.1 weight percent to 20 weight percent, preferably 0.5 to 5 percent by weight. After coating of the reinforcing agent using either a solution or emulsion, the liquid vehicle is removed by, for example, evaporation, devolatilization or vacuum drying. The resulting surface coating is desirably from 0.001 to 10 weight percent of the uncoated reinforcing agent weight. In a preferred embodiment the compatibilizer c) is fumaric acid or maleic anhydride modified polyphenylene ether.

The blend of the present invention may be toughened using one or more rubbery polymers. Desirably, more than one rubbery polymer is employed in order to provide optimum impact improvement by modification of both the monovinylidene aromatic polymer phase and the polyamide phase of the polymeric blend. Suitable rubbery polymers include elastomeric, optionally hydrogenated, block copolymers of monovinylidene aromatic monomers with butadiene or isoprene, silicone elastomers, borosilicate elastomers, elastomeric polyolefins, and polar monomer grafted derivatives of the foregoing. Compatibilizers to improve adhesion between the various matrix phases and the various rubbery polymer phases may be included in the formulation as well.

Preferred elastomers, especially for impact modification of the syndiotactic monovinylidene aromatic polymer component of the blend of the present invention especially include one or more domain forming rubbery polymers. Such domain forming rubbery polymers desirably possess extremely high melt viscosity, that is, very low melt flow. Such polymers having high melt viscosity are not drawn into extremely thin sections by the shear forces of the compounding process, and retain greater ability to reform discrete rubber particles more closely resembling spherical particles upon discontinuance of shearing forces. Additionally, the domain forming rubbery polymer beneficially should retain sufficient elastic memory to reform droplets in the melt when substantial shearing forces are absent.

Generally, higher molecular weight domain forming rubbery polymers possess increased melt viscosity. Accordingly, preferred domain forming rubbery polymers are those having Mw from 100,000 to 400,000 Daltons, more preferable from 150,000 to 300,000 Daltons, and having Tg less than 25° C., more preferably less than 0° C. Weight average molecular weights recited herein for domain forming rubbery polymers are apparent values based on a polystyrene standard, derived from gel permeation chromatography data, and not corrected for hydrodynamic volume differences between polystyrene and other polymeric components. Low molecular weight block copolymers, that is, polymers having molecular weight less than 100,000 Daltons, have been found to possess insufficient melt viscosity to achieve the desired rubber droplet formation. Most preferred domain forming rubbery polymers are those having a melt flow rate, Condition X (315° C., 5.0 Kg) from 0 to 0.5 g/10 min. Typical domain forming rubbery polymers include lower molecular weight (higher melt index) copolymers of styrene and a rubber such as butadiene or isoprene, including styrene/butadiene/styrene triblock copolymers, hydrogenated styrene/butadiene/styrene triblock copolymers, styrene/butadiene block copolymers, styrene/isoprene block copolymers, or hydrogenated derivatives thereof. Preferred block copolymers are those containing from 20 to 75 weight percent styrene with the remainder comprising butadiene, isoprene or a hydrogenated derivative thereof.

The domain forming rubbery polymer may also act as the compatibilizer between the syndiotactic monovinylidene aromatic polymer and other components of the resin blend. Typically, such domain forming rubbery block copolymers will act as a compatibilizer if the copolymer contains a compatibilizing amount of monovinylidene aromatic block. Generally, a compatibilizing amount will be at least 30 weight percent, typically at least 40 weight percent, preferably at least 50 weight percent, more preferably at least 60 weight percent and most preferably at least 70 weight percent monovinylidene aromatic block. Alternatively, a second block copolymer having lower molecular weight than the domain forming rubbery block copolymer may be employed to assist in the foregoing compatibilization.

Further alternatively, a polyolefin resin, especially a copolymer of ethylene and an α-olefin may also be utilized as all or as a portion of the domain forming rubbery polymer. Preferred α-olefins have from 3 to 20 carbon atoms. More preferred α-olefins have from 3 to 8 carbon atoms. Exemplary comonomers include propene, 1-butene, 1-pentene, 4-methyl-1-pentene, 1-hexene, and 1-octene. The low density polyethylene may also contain, in addition to the α-olefin, one or more further comonomers, such as diolefins, ethylenically unsaturated carboxylic acids (both mono- and difunctional) as well as derivatives of these acids, such as esters and anhydrides. Exemplary of such additional comonomers are acrylic acid, methacrylic acid, vinyl acetate and maleic anhydride. The low density polymers suitable for use in the present compositions can be further characterized by their homogeneity and degree of long chain branching.

Elastomeric polyolefins include any polymer comprising one or more C₂₋₂₀ α-olefins in polymerized form, having Tg less than 25° C., preferably less than 0° C. Examples of the types of polymers from which the present elastomeric polyolefins are selected include homopolymers and copolymers of α-olefins, such as ethylene/propylene, ethylene/1-butene, ethylene/1-hexene or ethylene/1-octene copolymers, and terpolymers of ethylene, propylene and a comonomer such as hexadiene or ethylidenenorbornene. Grafted derivatives of the foregoing rubbery polymers such as polystyrene-, maleic anhydride-, polymethylmethacrylate- or styrene/methyl methacrylate copolymer-grafted elastomeric polyolefins may also be used.

The elastomeric polyolefins are preferably softened by incorporation of an aliphatic oil to extend the polyolefin phase, making it softer and more readily dispersed into the syndiotactic vinyl aromatic polymer phase. The extending oils, also referred to as paraffinic/naphthenic oils, are usually fractions of refined petroleum products having less than about 30 percent by weight of aromatics (by clay-gel analysis) and having viscosities between about 100 and 500 SSU at 100° F. (38° C.). Commercial extending oils include SHELLFLEX® oils, numbers 310, 371 and 311 (which is a blend of 310 and 371), available from Shell Oil Company or Drakeol™, numbers 34 or 35, available from Penreco division of Pennzoil Products Company. The amount of extending oil employed varies from 0.01 to 35.0 weight percent, preferably from 0.1-25 percent, most preferably from 2-25 weight percent based on the weight of the elastomeric polyolefin.

Preferred elastomeric polyolefins for use herein are such polymers that are characterized by a narrow molecular weight distribution and a uniform branching distribution. Preferred elastomeric polyolefins are linear or substantially linear ethylene interpolymers having a density from 0.85 to 0.93 g/cm³, a melt index from 0.1 to 5 g/10 min, and a polydispersity (Mw/Mn) of from 1.8 to 5. Such polymers are preferably those prepared using a Group 4 metal constrained geometry complex by means of a continuous solution polymerization process, such as disclosed in U.S. Pat. Nos. 5,272,236 and 5,278,272, which are hereby incorporated by reference. More preferred elastomeric polyolefins have a density of from 0.860 to 0.920 g/cm³, more preferably from 0.865 to 0.915 g/cm³, and especially less than or equal to 0.910 g/cm³.

The term “interpolymer” as used herein refers to polymers prepared by the polymerization of at least two different monomers. The generic term interpolymer thus embraces copolymers, usually employed to refer to polymers prepared from two different monomers, and polymers prepared from more than two different monomers.

While describing in the present invention a polymer or interpolymer as comprising or containing certain monomers, it is meant that such polymer or interpolymer comprises or contains polymerized therein units derived from such a monomer. For example, if the monomer is ethylene CH2═CH2, the derivative of this unit as incorporated in the polymer is —CH₂—CH₂—.

Where melt index values are specified in the present application without giving measurement conditions, the melt index as defined in ASTM D-1238, Condition 190° C./2.16 kg (formerly known as “Condition (E)” and also known as I2) is meant.

The term “substantially linear” ethylene polymer or interpolymer as used herein means that, in addition to the short chain branches attributable to intentionally added α-olefin comonomer incorporation in interpolymers, the polymer backbone is substituted with an average of 0.01 to 3 long chain branches/1000 carbons, more preferably from 0.01 long chain branches/1000 carbons to 1 long chain branches/1000 carbons, and especially from 0.05 long chain branches/1000 carbons to 1 long chain branches/1000 carbons.

Long chain branching is defined herein as a chain length of at least 1 carbon less than the number of carbons in the longest intentionally added α-olefin comonomer, whereas short chain branching is defined herein as a chain length of the same number of carbons in the branch formed from any intentionally added α-olefin comonomer after it is incorporated into the polymer molecule backbone. For example, an ethylene/1-octene substantially linear polymer has backbones substituted with long chain branches of at least 7 carbons in length, but it also has short chain branches of only 6 carbons in length resulting from polymerization of 1-octene.

The presence and extent of long chain branching in ethylene interpolymers is determined by gel permeation chromatography coupled with a low angle laser light scattering detector (GPC-LALLS) or by gel permeation chromatography coupled with a differential viscometer detector (GPC-DV). The use of these techniques for long chain branch detection and the underlying theories have been well documented in the literature, for example in Zimm, G. H. and Stockmayer, W. H., J. Chem. Phys., Vol. 17, p. 1301 (1949) and Rudin, A., Modern Methods of Polymer Characterization, John Wiley & Sons, New York (1991), pp. 103-112.

A. Willem deGroot and P. Steve Chum, both of The Dow Chemical Company, at the Oct. 4, 1994 conference of the Federation of Analytical Chemistry and Spectroscopy Society (FACSS) in St. Louis, Mo., U.S.A., presented data demonstrating that GPC-DV is a useful technique for quantifying the presence of long chain branches in substantially linear ethylene interpolymers. In particular, deGroot and Chum found that the level of long chain branches in substantially linear ethylene homopolymer samples measured using the Zimm-Stockmayer equation correlated well with the level of long chain branches measured using ¹³C NMR.

Further, deGroot and Chum found that the presence of octene does not change the hydrodynamic volume of the polyethylene samples in solution and, as such, one can account for the molecular weight increase attributable to octene short chain branches by knowing the mole percent polymerized octene in the sample. By deconvoluting the contribution to molecular weight increase attributable to 1-octene short chain branches, deGroot and Chum showed that GPC-DV may be used to quantify the level of long chain branches in substantially linear ethylene/1-octene copolymers.

deGroot and Chum also showed that a plot of Log(I2, Melt Index) as a function of Log(GPC, Weight Average Molecular Weight) as determined by GPC-DV illustrates that the long chain branching aspects (but not the branching extent) of substantially linear ethylene polymers are comparable to that of high pressure, highly branched low density polyethylene (LDPE) and are clearly distinct from ethylene polymers produced using Ziegler-type catalysts such as hafnium and vanadium complexes.

The empirical effect of the presence of long chain branching in the substantially linear ethylene/α-olefin interpolymers used in the invention is manifested as enhanced rheological properties which are quantified and expressed herein in terms of gas extrusion rheometry (GER) results, and/or in terms of melt flow ratio (I10/I2) increase.

In contrast to the term “substantially linear”, the term “linear” means that the polymer lacks measurable or demonstrable long chain branches, that is, the polymer is substituted with an average of less than 0.01 long branches/1000 carbons.

Substantially linear ethylene interpolymers as used herein are further characterized as having:

(i) a melt flow ratio, I10/I2≧5.63,

(ii) a molecular weight distribution or polydispersity, Mw/Mn, as determined by gel permeation chromatography and defined by the equation: (Mw/Mn)=(I10/I2)4.63,

(iii) a critical shear stress at the onset of gross melt fracture, as determined by gas extrusion rheometry, of greater than 4×10⁶ dynes/cm³, or a gas extrusion rheology such that the critical shear rate at onset of surface melt fracture for the substantially linear ethylene polymer is at least 50 percent greater than the critical shear rate at the onset of surface melt fracture for a linear ethylene polymer, wherein the substantially linear ethylene polymer and the linear ethylene polymer comprise the same comonomer or comonomers, the linear ethylene polymer has an I2, Mw/Mn and density within 10 percent of the substantially linear ethylene polymer and wherein the respective critical shear rates of the substantially linear ethylene polymer and the linear ethylene polymer are measured at the same melt temperature using a gas extrusion rheometer, and

(iv) a single differential scanning calorimetry, DSC, melting peak between −30° C. and 150° C.

Determination of the critical shear rate and the critical shear stress in regards to melt fracture as well as other rheology properties such as the “Theological processing index” (PI) is performed using a gas extrusion rheometer (GER). The gas extrusion rheometer is described by M. Shida, R. N. Shroff and L. V. Cancio in Polymer Engineering Science, Vol. 17, No. 11, p. 770 (1977), and in Rheometers for Molten Plastics, by John Dealy, published by Van Nostrand Reinhold Co. (1982) on pp. 97-99. The processing index is measured at a temperature of 190° C., at nitrogen pressure of 2500 psig (17 Mpa) using a 0.0296 inch (0.0117 cm) diameter, 20:1 L/D die with an entrance angle of 180°. The GER processing index is calculated in millipoise units from the following equation:

PI=2.15×10⁶ dynes/cm²/(1000×shear rate),

where: 2.15×10⁶ dynes/cm² is the shear stress at 2500 psi, (17 Mpa) and the shear rate is the shear rate at the wall represented by the following equation:

32Q′/(60 sec/min)(0.745)(diameter×2.54 cm/in)³,

where Q′ is the extrusion rate (g/min), 0.745 is the melt density of the polyethylene (g/cm³), and diameter is the orifice diameter of the capillary (inches).

The PI is the apparent viscosity of a material measured at apparent shear stress of 2.15×10⁶ dyne/cm².

For the substantially linear ethylene polymers described herein, the PI is less than or equal to 70 percent of that of a comparative linear olefin polymer having an I2 and Mw/Mn each within 10 percent of the substantially linear ethylene polymers.

The rheological behavior of substantially linear ethylene polymers can also be characterized by the Dow Rheology Index (DRI), which expresses a polymer's “normalized relaxation time as the result of long chain branching.” (See, S. Lai and G. W. Knight “ANTEC '93 Proceedings, INSITE™ Technology Polyolefins (ITP)—New Rules in the Structure/Rheology Relationship of Ethylene/α-Olefin Copolymers,” New Orleans, La., U.S.A., May 1993.) DRI values range from 0, for polymers which do not have any measurable long chain branching (for example, TAFMER™ products available from Mitsui Petrochemical Industries and EXACT™ products available from Exxon Chemical Company), to 15 and is independent of melt index. In general, for low- to medium-pressure ethylene polymers (particularly at lower densities), DRI provides improved correlation to melt elasticity and high shear flowability relative to correlations of the same attempted with melt flow ratios. For the substantially linear ethylene polymers useful in this invention, DRI is preferably at least 0.1, and especially at least 0.5, and most especially at least 0.8. DRI can be calculated from the equation:

DRI=3652879×τ°1.00649/(η°−1)/10

where τ is the characteristic relaxation time of the material and η° is the zero shear viscosity of the material. Both τ° and η° are the “best fit” values to the Cross equation, that is,

η/η°=1/(1+(γ·τ°)n)

where n is the power law index of the material, and η and γ are the measured viscosity and shear rate (rad/sec), respectively. Baseline determination of viscosity and shear rate data are obtained using a Rheometric Mechanical Spectrometer (RMS-800) under dynamic sweep mode from 0.1 to 100 rad/sec at 190° C. and a Gas Extrusion Rheometer (GER) at extrusion pressures from 1000 psi to 5000 psi (6.89 to 34.5 MPa), which corresponds to shear stress from 0.086 to 0.43 MPa, using a 0.0754 mm diameter, 20:1 L/D die at 190° C. Specific material determinations can be performed from 140° C. to 190° C. as required to accommodate melt index variations.

An apparent shear stress versus apparent shear rate plot is used to identify the melt fracture phenomena. According to Ramamurthy in Journal of Rheology, Vol. 30(2), pp. 337-357, 1986, above a certain critical flow rate, the observed extrudate irregularities may be broadly classified into two main types: surface melt fracture and gross melt fracture.

Surface melt fracture occurs under apparently steady flow conditions and ranges in detail from loss of specular gloss to the more severe form of “sharkskin.” In this disclosure, the onset of surface melt fracture (OSMF) is characterized as the beginning of losing extrudate gloss at which the surface roughness of extrudate can only be detected by 40× magnification. The critical shear rate at onset of surface melt fracture for the substantially linear ethylene polymers is at least 50 percent greater than the critical shear rate at the onset of surface melt fracture of a linear ethylene polymer having about the same I2 and Mw/Mn.

Gross melt fracture occurs at unsteady flow conditions and ranges in detail from regular (alternating rough and smooth or helical) to random distortions. The critical shear rate at onset of surface melt fracture (OSMF) and onset of gross melt fracture (OGMF) will be used herein based on the changes of surface roughness and configurations of the extrudates extruded by a GER.

The substantially linear ethylene polymers used in the invention may also be characterized by a single DSC melting peak. The single melting peak is determined using a differential scanning calorimeter standardized with indium and deionized water. The method involves 5 to 7 mg sample sizes, a “first heat” to 150° C. which is held for 4 minutes, a cool down at 10° C./minute to −30° C. which is held for 3 minutes, and heated at 10° C./minute to 150° C. for the “second heat.” The single melting peak is taken from the “second heat” heat flow versus temperature curve. Total heat of fusion of the polymer is calculated from the area under the curve.

For polymers having a density of 0.875 g/cm³ to 0.910 g/cm³, the single melting peak may show, depending on equipment sensitivity, a “shoulder” or a “hump” on the low melting side that constitutes less than 12 percent, typically less than 9 percent, and more typically less than 6 percent, of the total heat of fusion of the polymer. Such an artifact is observable for other homogeneously branched polymers such as EXACT™ resins (made by Exxon Chemical Company) and is discerned on the basis of the slope of the single peak varying monotonically through the melting region of the artifact. Such an artifact occurs within 34° C., typically within 27° C., and more typically within 20° C., of the melting point of the single peak. The heat of fusion attributable to an artifact can be separately determined by specific integration of its associated area under the heat flow versus temperature curve.

The term “polydispersity” as used herein is a synonym for the term “molecular weight distribution” which is determined as follows: The polymer or composition samples are analyzed by gel permeation chromatography (GPC) on a Waters 150° C. high temperature chromatographic unit equipped with three mixed porosity columns (Polymer Laboratories 103, 104, 105, and 106), operating at a system temperature of 140° C. The solvent is 1,2,4-trichlorobenzene, from which 0.3 percent by weight solutions of the samples are prepared for injection. The flow rate is 1.0 milliliters/minute and the injection size is 200 microliters.

The molecular weight determination is deduced by using narrow molecular weight distribution polystyrene standards (from Polymer Laboratories) in conjunction with their elution volumes. The equivalent polymer molecular weights are determined by using appropriate Mark-Houwink coefficients for polyethylene and polystyrene (as described by Williams and Word in Journal of Polymer Science, Polymer Letters, Vol. 6, p. 621 (1968), to derive the following equation:

Mpolyethylene=0.4316(Mpolystyrene).

Weight average molecular weight, Mw, is calculated in the usual manner according to the following formula:

Mw=Σi wi ·Mi,

where wi and Mi are the weight fraction and molecular weight, respectively, of the ith fraction eluting from the GPC column.

The rubbery polyolefin elastomer and domain forming rubbery polymer are typically present in ratios of from 0:100 to 100:0 based on only those two components, preferably 70:30 to 95:5 and more preferably 80:20 to 90:10. Preferred quantities of rubbery polymer or mixtures of polymers in the blend are from 2 to 20, most preferably 3 to 15 weight percent based on the weight of components a), b1), b2) and c).

Optionally, a compatibilizing polymer, which acts as a compatibilizer for the syndiotactic monovinylidene aromatic polymer or polyamide polymers and the rubbery polyolefin elastomer is included in the blend of the present invention. A compatibilizing polymer is highly desired if the domain forming rubbery polymer is not a compatiblilizing polymer for these two components or if a domain forming rubbery polymer is not present in the blend. A compatibilizing polymer typically comprises a block copolymer such as a lower molecular weight (higher melt index) styrene/butadiene/styrene triblock copolymer, a hydrogenated styrene/butadiene/styrene triblock copolymer, or a styrene/butadiene diblock copolymer, a styrene/isoprene block copolymer, or a hydrogenated derivative thereof. Preferred block copolymers are those containing from 45 to 75 weight percent styrene with the remainder comprising butadiene, isoprene or a hydrogenated derivative thereof.

The various polymeric components, but especially the polyamides b1 and b2) may be toughened by including a polar group functionalized polyolefin in the blend. Typical functional groups include carboxylic acids, carboxylic acid esters, anhydrides, amines, amides, epoxies, maleimides and any other functional group which will compatibilize the polyolefin with the polyamide phase. The preferred functional groups are those groups that can react with the polyamide or other polymeric component during melt blending, such as amines, epoxies, anhydrides and carboxylic acids. Typically the functionalized polyolefin is a maleated polyolefin. Maleated polyolefins are known in the art and are typically obtained by grafting maleic anhydride onto the polyolefin backbone. The polyolefin may be the same as or different from the rubbery polyolefin elastomer used as the rubbery polymer, if any. Typical maleated polyolefins include maleated alpha-olefins such as ethylene-octene copolymer, ethylene-hexene copolymer, ethylene-heptene copolymer and the like.

Maleation of the polyolefin may be done by in the melt, in solution, or in the solid state, and the process can be either continuous or batch. Various free radical initiators, including peroxides and azo compounds may be used to facilitate the maleation. All of these processes are well know and fully described in the art. Maleating agents can include anhydrides such as maleic anhydride, unsaturated dicarboxylic acids such as fumaric acid or other agents listed in columns 6-7 of U.S. Pat. No. 5,219,940.

The amount of polar group functionalized polyolefin employed in the blend of the present invention is typically from 0 to 10 weight percent based on the weight of components a), b1), b2) and c), preferably from 0.1 to 7, and more preferably from 1 to 5 weight percent.

Nucleators may also be used in the blend of the present invention. Such additives are compounds capable of reducing the time required for onset of crystallization of the syndiotactic monovinylidene aromatic polymer or polyamide polymers upon cooling from the melt. Nucleators provide a greater degree of crystallinity in a molding resin and more consistent levels of crystallinity under a variety of molding conditions. Higher levels of crystallinity are desired in order to achieve increased chemical resistance. In addition crystal morphology may be desirably altered. Examples of suitable nucleators for use herein are metal salts, especially aluminum salts of organic acids or phosphonic acids. Especially preferred compounds are aluminum salts of benzoic acid and C₁₋₁₀ alkyl substituted benzoic acid derivatives. A most highly preferred nucleator is aluminum tris(p-tert-butyl)benzoate. The amount of nucleator used should be sufficient to cause nucleation and the onset of crystallization in the syndiotactic vinylaromatic polymer in a reduced time compared to compositions lacking in such nucleator. Preferred amounts are from 0.1 to 5 weight percent, preferably from 0.1 to 3 weight percent and most preferably from 0.2 to 1 weight percent based on the weight of component a).

Additionally a reinforcing agent or filler can be used in the blend of the present invention. Suitable reinforcing agents include any mineral, glass, ceramic, polymeric or carbon reinforcing agent. Generally reinforcing agents are elongated, fibrous materials, having a length to diameter ratio (L/D) of greater than 5.0. Fillers are substances having L/D less than 5.0. Preferred particle diameters of the foregoing components are from 0.1 micrometers to 1 millimeter. Preferred reinforcing agents are glass fibers, glass roving or chopped glass fibers having lengths from 0.1 to 10 millimeters and L/D from 5 to 100. Suitable fillers include nonpolymeric materials designed to reduce the coefficient of linear thermal expansion of the resulting material, to provide color or pigment thereto, to reduce the flame propagation properties of the composition, or to otherwise modify the composition's physical properties. Suitable fillers include mica, talc, chalk, titanium dioxide, clay, alumina, silica, wollastonite, magnesium hydroxide, glass microspheres, and various pigments. The amount of reinforcing agent or filler employed is preferably from 10 to 50 weight percent, more preferably from 20 to 40 weight percent.

The reinforcing agent or filler may include a surface coating of a sizing agent or similar coating which, among other functions, may promote adhesion between the reinforcing agent and the remaining components, especially the matrix, of the composition. Suitable sizing agents may contain amine, aminosilane, epoxy, and aminophosphine functional groups and contain up to 30 nonhydrogen atoms. Preferred are aminosilane coupling agents and C₁₋₄ alkoxy substituted derivatives thereof, especially 3-aminopropyltrimethoxysilane.

Additional additives such as blowing agents, extrusion aids, antioxidants, plasticizers, stabilizers, ignition resistant additives, and lubricants, may also be included in the composition in amounts up to 10 percent, preferably up to 5 percent, by weight, based on final composition weight.

The blend of the present invention is typically produced by compounding all the components or subsets thereof, in a mixing device such as an extruder, ribbon blender, or any other suitable device or by the use of solution blending or other suitable technique. Desirably the components of the blend are melt plastified, optionally after first dry mixing the respective ingredients, and formed into the desired article, such as a molded object, film or fiber in one operation. This is because repeated heating of the resin, for example by first preparing compounded resin pellets and thereafter reextruding the compounded resin in the desired physical form, leads to degradation of certain components of the resin blend as well as further advancement of some components. For example, at temperatures required to heat plastify the syndiotactic vinyl aromatic polymer, typically from 360 to 400° C., preferably from 365 to 385° C., nylons, especially nylon 6, typically undergo further molecular weight increase through an advancement reaction, thereby affecting the physical properties of the resulting blend. Accordingly, in a preferred embodiment particularly suited for preparation of a fiber from a blend comprising from 95 to 80 weight percent of components b1) and b2) and 5 to 20 weight percent of a syndiotactic vinylaromatic polymer resin, preferably syndiotactic polystyrene, components b 1) and b2), optionally in combination with one or more additional components of the blend, are desirably first added to an extruder in pellet form and melt plastified in a first zone of the extruder. Thereafter the syndiotactic vinylaromatic polymer or a blend thereof with one or more other components, or the remaining components of the resin blend individually are added in one or more subsequent zones of the extruder. Sufficient mixing elements are fitted to the extruder, and the polymer blend is worked, optionally with externally supplied heating, to raise the temperature of the blend to at least 360° C., preferably a temperature from 365 to 380° C. Such heating may occur before, during or after the foregoing zone for addition of the syndiotactic vinylaromatic polymer. After forming in the foregoing manner, the resin blend may be cooled, if desired, to impart desired melt properties to the resin blend. Finally, the resin blend is expelled from the extruder and formed into the desired final shape. For production of fibers, the resin blend is extruded through a die to form a strand of the desired cross section shape and size and then drawn and optionally further shaped or modified such as by known physical techniques of quenching, partial quenching, wrinkling of the surface, sizing, differential forming, smoothing, crimping, twisting, etc. to impart the desired physical properties to the fiber.

The following examples are provided to illustrate the present invention. The examples are not intended to limit the scope of the present invention and they should not be so interpreted. Amounts are in weight parts or weight percentages unless otherwise indicated.

### EXAMPLES

### Example 1

Resin blends comprising syndiotactic polystyrene having Mw of approximately 250,000 (Questra™ F2250, available from The Dow Chemical Company, SPS), nylon 6 (Vydyne™ NA215, available from Solutia, Inc.) and nylon 6,6 (Vydyne™ 50BW, available from Solutia, Inc.) are prepared using the following procedure. All samples contained (by weight) 30 percent glass fiber (PPG 3540, available from PPG Inc., a stabilizer package (0.25 percent phenolic antioxidant and 0.25 percent phosphorous stabilizer, Irganox™ 1010 and Ultranox™ 2020, respectively, available from Ciba Chemicals, Inc.), 2.5 percent carbon black concentrate in syndiotactic polystyrene (concentrate 00064638, available from Clariant, Inc.), 0.4 percent WAX-OP, wax processing aid (available from Clariant, Inc,), 0.6 percent aluminum (p-t-butylbenzoate nucleator, and 3.0 percent fumaric acid modified polyphenylene oxide compatibilizer (FAPPO). All components are tumble blended together and compounded through a Werner Pfleiderer ZSK30 twin screw extruder. Barrel temperature settings of 275-280° C., 35 pounds per hour, and screw speed 350 rpm are used. Strands are cooled in a water bath and pelletized. Injection molding is done on a Mannesmann Demag D100-275 injection molding machine with barrel temperatures of 305-315° C. and mold temperature of 150° C.

TABLE 1

| | Run 1* | Run 2 | Run 3 | Run 4 | Run 5 |
|---|---|---|---|---|---|
| percent SPS | 31.5 | 31.5 | 31.5 | 31.5 | 31.5 |
| percent nylon 6 | | 5.0 | 10.0 | 15.0 | 20.0 |
| percent nylon 6,6 | 31.5 | 26.5 | 21.5 | 16.5 | 11.5 |

*comparative, not an example of the invention

The mechanical performance of the above blends is contained in Table 2. Flex, Tensile, DTUL, and Izod impact testing are measured using standard ASTM methods and conditions including ASTM D256, ASTM D638M-89 and ASTM D3764.

TABLE 2

| | | | | | |
|---|---|---|---|---|---|
| Property | Run 1* | Run 2 | Run 3 | Run 4 | Run 5 |

| | | | | | |
|---|---|---|---|---|---|
| Flex Strength MPa | 217.7 | 221.2 | 216,6 | 223.0 | 224.0 |
| Flex Modulus MPa | 10,076 | 10,152 | 9,959 | 9,945 | 9,903 |
| Izod kJ/m² 25° C. | 14.5 | 13.8 | 13.2 | 12.9 | 12.6 |
| Izod kJ/m2² −40° C. | 11.4 | 11.8 | 11.1 | 11.7 | 10.9 |
| DTUL ° C. | 243 | 236 | 223 | 217 | 209 |
| Tensile Strength MPa | 150.1 | 150.5 | 148.1 | 146.3 | 146.9 |
| Tensile Modulus MPa | 10,000 | 9,952 | 10,014 | 9,407 | 9,241 |
| Tensile Elongation¹ | 2.1 | 2.3 | 2.2 | 2.3 | 25 |

*comparative, not an example of the invention
¹percent, measured at break

Surface roughness was analyzed via surface profilimetry by making use of a two-dimensional line scan performed on five different areas of each sample at a length of 5.0 mm using a Tencor P-11 Surface Profilor (Serial number 10960163). The roughness measurements (in μm) are defined as:

Ra is the arithmetic average of the deviation of absolute values of roughness profile from mean line measured in sampling length.

Rq is the root-mean-squared or geometric average deviation of roughness profile from mean line measured in sampling length.

Rt is the maximum vertical excursion (peak-to-valley) within cursors measured from a line parallel to mean line.

Results are presented in Table 3 and FIG. 1.

TABLE 3

| Measurement | Run 1 * | Run 2 | Run 3 | Run 4 | Run 5 |
|---|---|---|---|---|---|
| Ra/St. dev.¹ | 0.053/0.016 | 0.050/0.014 | 0.031/0.008 | 0.028/0.009 | 0.029/0.010 |
| Ra minimum/max | 0.036/0.075 | 0.031/0.065 | 0.026/0.046 | 0.018/0.042 | 0.017/0.044 |
| Rq/St. dev.¹ | 0.111/0.021 | 0.117/0.031 | 0.076/0.014 | 0.080/0.023 | 0.074/0.024 |
| Rq minimum/max | 0.086/0.137 | 0.088/0.163 | 0.057/0.096 | 0.049/0.110 | 0.041/0.103 |
| Rt/St. dev.¹ | 1.774/1.775 | 2.171/0.854 | 1.639/0.448 | 1.580/0.626 | 1.442/0.383 |
| Rt minimum/max | 1.317/2.333 | 1.265/3.325 | 1.020/2.015 | 0.978/2.449 | 0.997/1.757 |

*comparative, not an example of the invention
¹standard deviation

For this particular resin blend, molded under the indicated conditions, improved surface roughness (Ra and Rq) is observed for Nylon 6 contents greater than 5, and especially greater than 10 weight percent. The observed decrease in Ra and Rq going from run 1 to run 5 indicates a trend toward smoother surfaces as the ratio of Nylon 6 to Nylon 6,6 increases.

### Example 2

A similar blend prepared substantially according to the procedure of Example 1 but substituting nylon 6/6,6 for nylon 6,6 is prepared. Physical properties of molded articles prepared therefrom, including surface roughness are similar to those of Example 1.

1. A polymer blend comprising:
a) a syndiotactic monovinylidene aromatic polymer,
b1) nylon 6,6,
b2) nylon 6, nylon 6/6,6 copolymer, or a mixture of nylon 6 and nylon 6/6,6 copolymer, and
c) a compatibilizer able to impart improved adhesion between components a), b1) and b2).

2. A polymer blend according to claim 1 comprising:
a) from 1.0 to 97.9 percent by weight of a syndiotactic monovinylidene aromatic polymer,
b1) from 1.0 to 97.9 percent by weight of nylon 6,6,
b2) from 1.0 to 97.9 percent by weight of nylon 6, nylon 6/6,6 copolymer, or a mixture of nylon 6 and nylon 6/6,6 copolymer, and
c) 0.1 to 10 weight percent by weight of a compatibilizer able to impart improved adhesion between components a), b1) and b2).

3. A polymer blend according to claim 1 suitable for use as a molding resin comprising:
a) from 10 to 90 percent of a syndiotactic monovinylidene aromatic polymer,
b1) from 10 to 60 weight percent nylon 6,6,
b2) from 4 to 15 weight percent nylon 6 or nylon 6/6,6 copolymer, and
c) from 0.2 to 10 weight percent of a compatibilizer able to impart improved adhesion between components a), b1) and b2).

4. A polymer blend according to any of claims 1-3 additionally comprising a filler or reinforcing agent in an amount from 0.2 to 50 weight percent.

5. A polymer blend according to claim 4 wherein the reinforcing agent is glass fiber.

6. A polymer blend according to claim 4 wherein the compatibilizer is a fumaric acid or maleic anhydride modified polyphenylene ether.

7. A polymer blend according to claim 5 wherein the compatibilizer is a fumaric acid or maleic anhydride modified polyphenylene ether.
